(19) United States
(12) Patent Application Publication
(10) Pub. No.: US 2013/0153397 A1
(43) Pub. Date: Jun. 20, 2013

(54) DISTILLATION APPARATUS

(71) Applicant: HANS HEIDOLPH GmbH & Co. KG, Kelheim (DE)

(72) Inventors: Joachim Carl, Stein (DE); Patrick Nico, Steinheim (DE); Jochen Zehnder, Nurnberg (DE)

(73) Assignee: HANS HEIDOLPH GmbH & Co. KG, Kelheim (DE)

(21) Appl. No.: 13/688,653

(22) Filed: Nov. 29, 2012

(30) Foreign Application Priority Data
Dec. 19, 2011 (DE) DE 102011121650.6

(51) Int. Cl. B01D 3/00

(52) U.S. Cl. CPC B01D 3/00
USPC 203/4; 202/262

(57) ABSTRACT

The invention relates to a distillation apparatus, in particular a distillation apparatus configured as a piece of laboratory equipment, having a distillation vessel for receiving a mixture to be distilled, wherein a removal device is provided which is configured for the automated removal of a distillation residue from the distillation vessel.

### CROSS-REFERENCE TO RELATED APPLICATIONS

This application claims priority of German Patent Application DE 102011121650.6 filed Dec. 19, 2011.

### FIELD OF THE INVENTION

The present invention relates to a distillation apparatus, in particular to a distillation apparatus configured as a piece of laboratory equipment, having a distillation vessel for receiving a mixture to be distilled.

### BACKGROUND OF THE INVENTION

Distillation apparatus are known from the prior art in which the distillation takes place in batch operation. In this respect, the distillation vessel is first filled with the starting materials. The distillation then takes place, i.e. the mixture is separated by thermal evaporation and subsequent condensation of at least one of the starting materials into a distillate or condensate, on the one hand, and into a residue remaining in the distillation vessel, on the other hand. The distillation vessel is then removed from the total apparatus and emptied by pouring out the residue. Subsequently, the distillation vessel can be prepared, for example cleaned and serviced, for a next filling.

The product to be obtained is, however, frequently, e.g. in the case of extraction or of a chromatographic separation process, only contained in small amounts in the mixture to be distilled. A plurality of individual batch runs then have to be carried out to obtain a sufficient quantity of distillate. This is time-consuming.

### SUMMARY OF THE INVENTION

It is the underlying object of the invention to provide a distillation apparatus of the initially named kind which makes it possible also to produce a larger quantity of distillate or distillate residue quickly.

This object is satisfied by a distillation apparatus having the features of claim 1 and in particular in that a removal device is provided which is configured for an automated, in particular automatic, removal of a distillation residue from the distillation vessel.

The distillation apparatus can carry out the emptying of the distillation vessel independently thanks to the automation, i.e. the emptying of the distillation vessel no longer has to be carried out manually. A multiple manual emptying of the distillation vessel can in particular be dispensed with so that the distillation or the distillation process can be accelerated overall.

Usually, a condenser is provided for cooling the evaporated substance or substances and a distillate collection vessel, in particular a collecting flask, is provided for collecting the distillate. The distillation apparatus can be a rotary evaporator and the distillation vessel can be an evaporating flask. The distillation apparatus can, however, also be a rectification plant in a further example.

The distillation enables different substances contained in a mixture, in particular mutually dissolved substances, to be separated from one another. The residue is the respective mixture located in the distillation vessel at a respective point in time, in particular during an ongoing distillation process, whose proportional composition changes in the course of a distillation process. As a rule, in addition to the at least one substance not to be evaporated, the residue at the respective point in time therefore also contains a portion of the at least one substance which is to be evaporated and which has not yet evaporated at the respective point in time.

The automated removal of the distillation residue from the distillation vessel in particular takes place discontinuously, i.e. with interruptions. For example, the removal is interrupted if the residue in the distillation vessel has fallen to or below a predefined filling level, if a predefined time since a start of the removal has elapsed or if a predefined volume of distillation residue has been extracted. Mixture to be distilled can then be supplied to the distillation vessel again for a further run or a further distillation process or the distillation process continued with it. The removal can therefore be divided into a plurality of removal phases spaced apart from one another in time. The removal and supply can be carried out alternately. Generally, however, a continuous removal is also conceivable.

In accordance with a preferred embodiment of the invention, the automated removal of the distillation residue, in particular a respective start or beginning of the automated removal of the distillation residue takes place automatically and/or in dependence on at least one distillation parameter. An automatic start is to be understood as a start which is not triggered manually by an operator of the distillation apparatus. A correspondingly designed control device can be provided for the removal taking place automatically and/or in dependence on at least one distillation parameter. An automated removal can in particular also be started a multiple of times due to a multiple supply of the mixture to be distilled into the distillation vessel. A distillation parameter is in particular a parameter which displays the progress of an ongoing distillation process. A distillation parameter can, for example, be a chemical parameter and/or a physical parameter of the mixture or of a part thereof or a predefined time period.

At least one respective measuring device, for example a respective sensor, is in particular provided for determining the at least one distillation parameter. The distillation parameter can be determined directly or indirectly from the measurement signal or signals of the measured device or devices.

The respective start preferably takes place when the at least one distillation parameter reaches or exceeds or falls below a predefined limit value. The respective limit value can therefore be an upper or lower limit value—depending on the respective distillation parameter. The predefined limit value is preferably adjustable, i.e. its value is variable, and can thus be matched to the respective distillation.

The at least one distillation parameter corresponds, for example, to a measure for the concentration of a substance of the mixture in the distillation vessel. The measure can be a measure which indicates the named concentration or allows a conclusion on it to be drawn or it can be the concentration of a substance of the mixture in the distillation vessel itself. The focus can, for example, be on the concentration of a substance to be evaporated or on the concentration of a substance remaining in the distillation vessel on the distillation.

The at least one distillation parameter is preferably selected from the group comprising the pH of the distillation residue, the electric conductivity of the distillation residue, the extinction coefficient of the distillation residue, the time duration of the distillation, the filling level of the distillation residue in the distillation vessel, the mass of the distillation residue in the distillation vessel, the volume of the distillation residue in the distillation vessel, the filling level of the distillate in a distillate collecting vessel, the mass of the distillate in a distillate collecting vessel the volume of the distillate in a distillate collecting vessel, a variation of a boiling temperature of the mixture, a pressure change in the distillation vessel, the volume flow of the distillate, the mass flow of the distillate and the switch-on duration of a supply valve or of any desired sub-group hereof. The switch-on duration of a supply valve is the lower, the more distillation residue is located in the distillation vessel.

In accordance with another embodiment of the invention, a timing element or a timing element control, in particular with a timer or a clock, is provided for the automated, in particular automatic, removal of the distillation residue, in particular for a respective start and/or a respective end of the removal. The removal of the distillation residue can then take place in dependence on a predefined time duration. in particular after the end of a predefined time duration and in particular for a predefined time duration.

Additionally or alternatively, a respective start of the automated removal of the distillation residue can be manually triggerable. The advantage of not having to release the distillation vessel from the distillation apparatus for emptying is also ensured in this case. The removal is in thus respect still automated.

The automatic removal of the distillation residue in particular takes place when actually no distillation process is in progress. A disturbance of the distillation process is hereby avoided. The automated removal of the distillation residue can generally, however, also take place during an ongoing distillation process.

The automated removal of the distillation residue preferably takes place while a partial vacuum is applied to the distillation vessel. A vacuum applied to the distillation vessel then does not have to be broken. It is, however, generally also possible that the removal takes place at atmospheric pressure or without application of a partial vacuum to the distillation vessel.

The removal device preferably includes at least one suction line extending into the distillation vessel and optionally additionally a suction pump connected to the suction line and/or a valve connected to the suction line. If a partial or full vacuum is applied to a closed residue collection vessel in which the distillation residue to be extracted is to be collected, a suction pump can be dispensed with on a correspondingly directed pressure difference between the distillation vessel and the residue collection vessel since the distillation residue is then automatically sucked into the residue collection vessel due to the pressure difference. This is in particular of advantage when the suction pump is damaged by the distillation residue. A backflow of the distillation residue into the distillation vessel can be prevented by the provision of the aforesaid valve with a pressure difference directed against it.

The removal device or at least a part thereof can in particular be led through a ground socket of the distillation vessel.

In accordance with another embodiment of the invention, a supply device is provided which is configured for the automated, in particular automatic, supply of the mixture to be distilled into the distillation vessel. The supply of the starting materials can thus also be accelerated. The supply device can include a supply line and optionally a pump. On application of a partial vacuum to the distillation vessel the pump is not absolutely necessary since the mixture is automatically sucked into the distillation vessel due to the then prevailing pressure difference. The removal is preferably interrupted when the mixture to be distilled is supplied to the distillation vessel in an automated manner, optionally for a further run.

The above-explained further developments of the invention are in particular to be understood such that the distillation apparatus or at least a respective part thereof is configured to implement the respective further development.

The invention furthermore relates to a method for distilling a mixture located in a distillation vessel, with a distillation residue being extracted from the distillations vessel in an automated manner.

Preferred embodiments of the method in accordance with the invention result in an analog manner from the further developments of the distillation apparatus in accordance with the invention.

### BRIEF DESCRIPTION OF THE DRAWINGS

A non-restricting embodiment of the invention is represented in the drawing and will be described in the following. There is shown, in a schematic representation,

FIG. 1 a rotary evaporator having an evaporating flask and a removal device for the automated removal of a distillation residue from the evaporating flask.

### DETAILED DESCRIPTION OF THE PREFERRED EMBODIMENTS

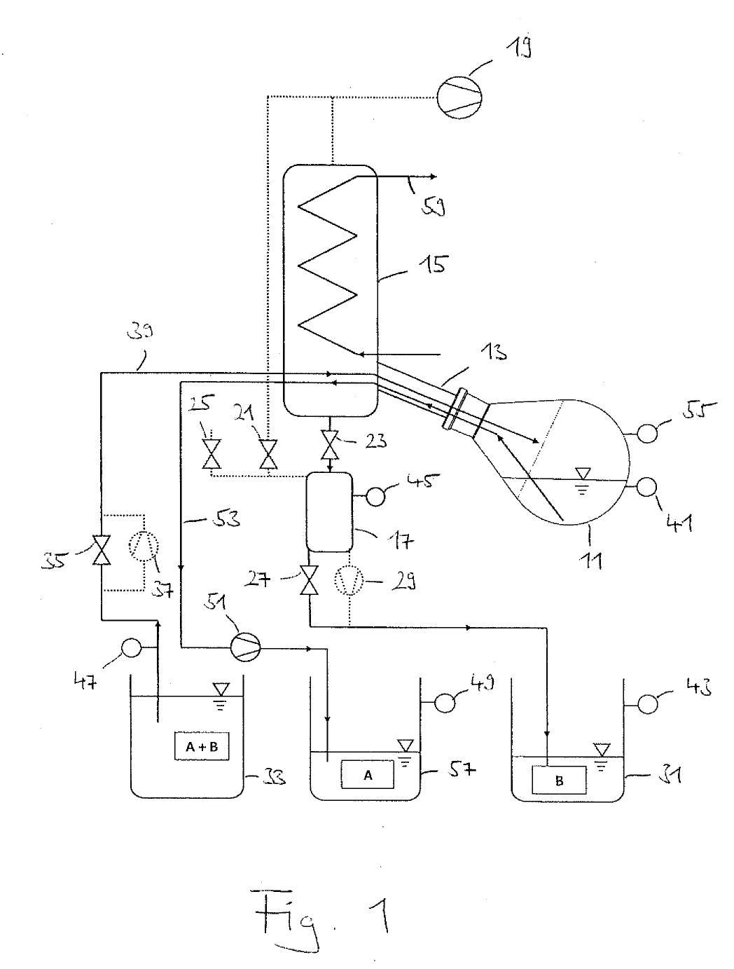

The laboratory rotary evaporator shown in FIG. 1 includes a rotary drive, not shown, for an evaporator flask 11 which is designed as a round bottomed flask or a V-shaped flask or the like and which can be heated in a heating bath, not shown, to evaporate a distillate from a liquid mixture present therein. The evaporated distillate then moves via a vapor passage 13 led through the rotary drive into a condenser 15 which is flowed through by a cooling medium 59 to condense there. Subsequently, the condensed distillate is collected in a collecting flask 17, with a valve 23 being provided between the condenser 15 and the collecting flask 17. The distillation residue remaining in the evaporator flask 11 can be further processed or analyzed.

Furthermore, a vacuum pump 19 is provided to apply a partial vacuum to the condenser 15 and thus to the evaporation flask 11 as well as additionally also—via an evacuation valve 21—optionally to the collecting flask 17, whereby the boiling temperature of the distillate can be lowered. Furthermore, the collecting flask 17 can be connected to atmospheric pressure via a venting valve 25.

The distillate collected in the collecting flask 17 can be let out or conveyed via a further valve 27 and/or a pump 29 into a collecting container 31 for the distillate. A filling level sensor 45 is provided for determining the filling level of the distillate in the collecting flask 17. If the filling level there reaches a predefined upper limit, the valve 27 is automatically opened or the pump 29 is put into operation by means of a control, not shown—to empty the collecting flask 17 at least partly. The filling level of the collecting container 31 is determined by means of a further filling level sensor 43 to avoid an overflow of the collecting container 31. Alternatively, the filling level of the collecting container 31 can, for example, also be monitored by means of a weight sensor or by means of scales.

Furthermore, a storage container 33 is provided for the mixture to be distilled which comprises, for example, two mutually different starting materials A and B. The storage container 33 is in fluid communication with the evaporating 11 flask via a supply device comprising a supply line 39 which projects through the vapor passage 13 into the interior of the evaporating flask 11 and comprising a supply valve 35 arranged in the supply line 39 and/or comprising a pump 37 arranged there. The supply valve 35 or the pump 37 respectively is likewise controllable via the aforesaid control and in dependence on the filling level of the mixture in the evaporating flask 11. As soon as the filling level of the mixture in the evaporating flask 11 has fallen below a predefined filling level, mixture to be distilled is automatically metered from the storage container 33 into the evaporating piston 11, in particular so long until a predefined filling level is reached in the evaporating flask 11. The filling level of the mixture in the evaporating flask 11 is determined by a further filling level sensor 41. The mass flow and/or volume flow through the supply line 39 can be measured, regulated and/or monitored using a sensor 47.

In accordance with the invention, the rotary evaporator furthermore includes a fixedly installed or attached removal device to extract or expel the distillation residue located in the evaporating flask 11 at least partly from the evaporating flask 11. The removal device includes a suction pump 51 by which distillation residue remaining in the evaporating flask 11 can be pumped off via a suction line 53. The suction line 53 for this purpose projects through a ground socket of the evaporating flask 11 into the evaporating flask 11. The extracted distillation residue is collected in a residue collecting vessel 57 whose filling level can be monitored using a further filling level sensor 49.

The suction pump 51 is—as also the valve 27 or the pump 29 and the valve 35 or the pump 37—controllable by the aforesaid control, and indeed in dependence on a measurement signal which corresponds to a physical and/or chemical parameter of the mixture or distillation residue currently present in the evaporating flask 11 and which is provided by a sensor 55 arranged in or at the evaporating flask 11. If the measurement signal reaches, exceeds or falls below a predefined adjustable limit value, the distillation residue is partly or completely pumped off out of the evaporating flask 11.

The parameter is a parameter which delivers a measure for the progress of an ongoing distillation process. The parameter in particular provides information—directly or indirectly—on which concentration the substance to be evaporated from the mixture and/or the substance not to be evaporated in the distillation residue has or which absolute and/or relative quantity of the substance to be evaporated is still contained in the distillation residue. For example, the sensor can be a weight sensor which measures the respective weight of the distillation residue currently located in the evaporating flask 11, with the removal of the distillation residue being started when the weight signal reaches or exceeds a predefined weight value.

The aforesaid sensors, in particular the sensors 45 and 55, are not absolutely necessary for the control of the removal of the distillation residue. In accordance with a further embodiment of the invention, the removal of the distillation residue can also take place, in particular exclusively, in a time-controlled manner.

The invention in particular provides an automatic removal of the distillation residue from the respective distillation vessel. Particularly with laboratory distillation apparatus in which the capacity of the distillation vessel is naturally limited, the advantage results in connection with an automatic supply of the mixture to be distilled into the distillation vessel that even larger quantities which exceed the capacity of the distillation vessel can be distilled in an unmonitored permanent operation in which alternately a removal of distillation residue from the distillation vessel and a supply of mixture to be distilled into the distillation vessel takes place, for example overnight or at the weekend.

1. A distillation apparatus having a distillation vessel (11) for receiving a mixture to be distilled, wherein a removal device (51, 53) is provided which is configured for the automated removal of a distillation residue from the distillation vessel (11).

2. A distillation apparatus in accordance with claim 1, wherein the distillation apparatus is configured as a piece of laboratory equipment.

3. A distillation apparatus in accordance with claim 1, wherein the automated removal of the distillation residue from the distillation vessel (11) takes place discontinuously.

4. A distillation apparatus in accordance with claim 1, wherein the automated removal of the distillation residue takes place automatically and/or in dependence on at least one distillation parameter.

5. A distillation apparatus in accordance with claim 1, wherein a respective start of the automated removal of the distillation residue takes place automatically and/or in dependence on at least one distillation parameter.

6. A distillation apparatus in accordance with claim 4, wherein
at least one respective measuring device (55) is provided for determining the at least one distillation parameter.

7. A distillation apparatus in accordance with claim 5, wherein
at least one respective measuring device (55) is provided for determining the at least one distillation parameter.

8. A distillation apparatus in accordance with claim 5, wherein the respective start takes place when the at least one distillation parameter reaches a predefined limit value.

9. A distillation apparatus in accordance with claim 8, wherein the predefined limit value is adjustable.

10. A distillation apparatus in accordance with claim 4, wherein the at least one distillation parameter corresponds to a measure for the concentration of a substance of the mixture in the distillation vessel (11).

11. A distillation apparatus in accordance with claim 5, wherein the at least one distillation parameter corresponds to a measure for the concentration of a substance of the mixture in the distillation vessel (11).

12. A distillation apparatus in accordance with claim 1, wherein a time control is provided for the automated removal of the distillation residue.

13. A distillation apparatus in accordance with claim 1, wherein a respective start of the automated removal of the distillation residue can be triggered manually.

14. A distillation apparatus in accordance with claim 1, wherein the automated removal of the distillation residue takes place when no distillation process is in progress.

15. A distillation apparatus in accordance with claim 1, wherein the automated removal of the distillation residue takes place while a partial vacuum is applied to the distillation vessel (11).

16. A distillation apparatus in accordance with claim 1, wherein the removal device (51, 53) includes at least one suction line (53) extending into the distillation vessel (11).

17. A distillation apparatus in accordance with claim 1, wherein the removal device (51, 53) or at least a part (53) of the removal device is led through a ground socket of the distillation vessel (11).

18. A distillation apparatus in accordance with claim 1, wherein a supply line (35, 37, 39) is provided which is configured for the automated supply of the mixture to be distilled into the distillation vessel (11).

19. A method of distilling a mixture located in a distillation vessel (11), comprising the step of removing a distillation residue from the distillation vessel (11) in an automated manner.
